(19) United States
(12) Patent Application Publication
(10) Pub. No.: US 2002/0094395 A1
(43) Pub. Date: Jul. 18, 2002

(54) Methods of forming and using a corsage bag

(76) Inventor: Donald E. Weder, Highland, IL (US)

Correspondence Address: Dunlap, Codding & Rogers, P.C., Suite 420, 9400 North Broadway, Oklahoma City, OK, 73114, US

(21) Appl. No.: 10/082,447

(22) Filed: Feb. 22, 2002

Related U.S. Application Data
(63) Continuation of application No. 09/455,275, filed on Dec. 6, 1999, now abandoned.

(51) Int. Cl. B32B 1/02; F16L 1/00

(52) U.S. Cl. 428/34.1; 428/35.7; 428/35.2; 156/308.4

(57) ABSTRACT

A bag capable of displaying and protecting an item during shipping, transportation, handling and/or display. The bag is fabricated from at least one sheet of material which is formed into a tubular sheath having a heat-sealable bonding material disposed solely on portions of the tubular sheath of material so as to bondingly hold the tubular sheath of material in a bag-like configuration. The portions of the tubular sheath having the heat-sealable bonding material thereon may be configured as either lap or fin seals or combinations thereof. There is also provided methods for producing such a bag and methods for its use.

### CROSS-REFERENCE TO RELATED APPLICATIONS

None

### BACKGROUND OF THE INVENTION

1. Field of the Invention

The present invention relates generally to a bag and more particularly, but not by way of limitation, to a bag that is capable of encompassing an item such as a corsage. The present invention also relates to methods of making such a bag as well as methods for its use.

2. Brief Summary of the Related Art

Bags and processes for producing bags are well known in the art. In the past, such bags required numerous seals, folds, and adhesive material covering the blank of material from which the bag was formed. The materials involved in such a process and article can be quite costly and cause the bag to be economically unfeasible for use. Therefore, new and improved bags and methods for producing such bags requiring less material and adhesive are being sought.

### BRIEF DESCRIPTION OF THE SEVERAL VIEWS OF THE DRAWINGS

FIG. 1 is a pictorial plan view of a sheet of material employed to form a bag in accordance with the present invention.

FIG. 2 is a pictorial representation of an articulated form of a bag of the present invention formed from the sheet of material of FIG. 1.

FIG. 3 is a pictorial plan view of another sheet of material employed to form a bag in accordance with the present invention.

FIG. 4 is a pictorial representation of an articulated form of a bag of the present invention formed from the sheet of material of FIG. 3.

FIG. 5 is a pictorial plan view of another sheet of material employed to form a bag in accordance with the present invention.

FIG. 6 is a pictorial representation of an articulated form of a bag of the present invention formed from the sheet of material of FIG. 5..

FIG. 7 is a pictorial plan view of yet another sheet of material employed to form a bag in accordance with the present invention.

FIG. 8 is a pictorial representation of an articulated form of a bag of the present invention formed from the sheet of material of FIG. 7.

### DETAILED DESCRIPTION OF THE INVENTION

According to the present invention, a bag is provided for encasing an item, such as a corsage. Broadly, the bag is constructed from a sheet of material having a bonding material disposed on isolated and individualized sections of the sheet of material. Once the bonding material is on the sheet of material, it is articulated into a bag having fin and/or lap seams at the point of sealing. In one embodiment, the bonding material may be a heat sealable lacquer which is applied to isolated and individualized sections of the sheet of material.

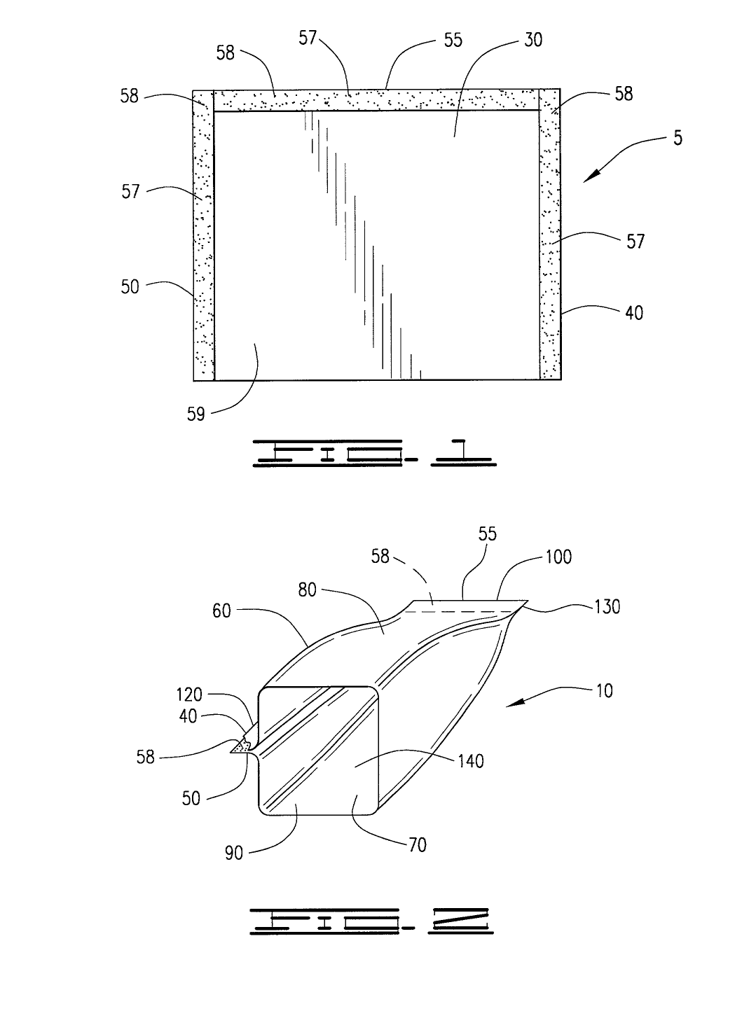

Referring now to the drawings, and more particularly to FIG. 1, shown therein and designated by reference numeral 5 is a sheet of material. The sheet of material 5 is articulated into a bag 10 as shown in FIG. 2.

The term “sheet of material” when used herein means at least one flexible sheet of material. The thickness of the sheet of material may vary, but generally the sheet of material will have a thickness in a range from about 0.0002 mil to about 30 mil, and more desirably from about 0.01 mil to about 20 mil. The sheet of material may be any material capable of being articulated into a bag configuration, such as polymeric film, foil, paper, tissue, laminations and combinations thereof. The sheet of material may have a substantially textured surface. The term “paper” as used herein, means treated or untreated paper, corrugated paper or cardboard or any other form of paper material. The term “polymeric film” means a synthetic polymer such as polypropylene or a naturally occurring polymer such as cellophane. A polymeric film is relatively strong and not as subject to tearing as might be the case with paper or foil.

When the sheet of material is a polymeric film, a flexible sheet of liquified thermoplastic film can be extruded from an extruder in a conventional and well known manner. The flexible sheet of liquified thermoplastic film can be passed through a cooler which cools the liquified thermoplastic film into a sheet of solidified thermoplastic film, i.e. the sheet of material. The sheet of material may also be formed of two or more sheets of material which have been laminated or adhesively connected to one another.

The sheet of material may also vary in color. Further, the sheet of material may be provided with designs or decorative patterns which are printed, etched, and/or embossed therein using inks or other printing materials. When printed and embossed, the design or decorative patterns may be in register, may be out of register, or may be partially in register and partially out of register. An example of an ink which may be applied to the surface of the sheet of material is described in U.S. Pat. No. 5,147,706 entitled “Water Based Ink on Foil and/or Synthetic Organic Polymer” issued to Kingman on Sep. 15, 1992 and which is hereby incorporated herein by reference. Additionally, the sheet of material may have various colorings, flocking and/or metallic finishes, or other decorative surface ornamentation applied separately or simultaneously or may be characterized totally or partially by pearlescent, translucent, transparent, iridescent or the like qualities. Each of the above named characteristics may occur alone or in combination. The sheet of material may also be opaque, translucent, partially clear, and/or tinted yet having some transparency.

As shown in FIG. 1, the sheet of material 5 has a first surface 30, the first surface 30 having a first edge portion 40, a second edge portion 50, and a third edge portion 55. A bonding material 58 is disposed on a portion of the first surface 30 such that the bonding material 58 extends along the first edge portion 40, the second edge portion 50, and the third edge portion 55 substantially as shown in FIG. 1. Thus, the first, second, and third edge portions 40, 50, and 55 of the first surface 30 define areas of adhesion 57. The remaining portion of the sheet of material 5, which is free of adhesive, defines a substantially open area 59 which does not have the bonding material 58 thereon.

The bonding material 58 may be disposed in a continuous manner across the entirety of the first edge portion 40, the second edge portion 50, and the third edge portion 55 of the first surface 30. In an alternative embodiment, the bonding material 58 may be selectively applied in such a manner as to not completely cover the first edge portion 40, the second edge portion 50, and the third edge portion 55. In this embodiment, the bonding material 58 may be applied as a plurality of dots, strips, or dabs of the bonding material 58 which are applied to alternating areas of the first edge portion 40, the second edge portion 50, and the third edge portion 55. Furthermore, the bonding material 58 can be applied in any geometric form and in any pattern. In any event, it is to be appreciated that the bonding material 58 is not applied to the entirety of the sheet of material 5, but rather to selective parts of the sheet of material 5 to leave the open area 59 on the first surface 30 of the sheet of material 5.

The bonding material 58 may be applied to the sheet of material 5 in any manner which allows for the timely and economical placement of the bonding material 58 onto the sheet of material 5. For example, the bonding material 58 may be printed onto the sheet of material 5 by brushes, rollers, wires, sponges, and/or other mechanical and/or automated processes. Furthermore, the bonding material 58 may be printed onto the sheet of material with a jet printer, such as an ink jet printing apparatus. In any event, any mechanical or automated process which allows for the correct placement of the bonding material 58 onto the sheet of material 5 is contemplated for use.

The term “bonding material” may be any material capable of bondingly holding at least two surfaces in a substantially adjacent position. The bonding material may be a hot stamped adhesive, a pressure adhesive, a hot melt adhesive, a water-proof adhesive, a cohesive, a heat sealable lacquer and combinations thereof. The term “heat sealable lacquer” as used herein means a coating substance consisting of resinous materials, such as cellulose esters, cellulose ethers, shellac, gum, alkyd resins and the like, which are dissolved in a solvent that evaporates rapidly on application such as ethyl alcohol, thereby leaving a tough, adherent film. Lacquers which are useful in the present invention maybe mixtures, such as lacquers produced by mixing styrene-acrylic emulsions, such as Lucidene 603 and Lucidene 395 (Morton International, Inc., 100 North Riverside Plaza, Chicago, Ill. 60606) with a non-ionic surfactant, such as Sufynol 465 (Air Products and Chemicals, Inc., 751 Hamilton Boulevard, Allentown, Pa. 18195-1501) and ammonia (G.S. Robbins and Company, 126 Chateau Avenue, St. Louis, Mo. 63102). The lacquer produced as described above may also contain a wax emulsion in water, such as Liquitron 440 (Carrol Scientific, Inc., 5401 S. Dansher Road, Countryside, Ill. 60525).

As stated above, the bonding material 58 may be an adhesive, such as a pressure sensitive adhesive, or a cohesive. Where the bonding material 58 is a cohesive, a similar cohesive material must be placed on both surfaces which are to be bonded together. As stated above, the bonding material 58 may be heat sealable and in this instance, the adjacent portions of the materials must be brought into contact and then heat must be applied to affect the seal. The lacquers described above are but one type of the bonding material 58 which is heat sealable. The bonding material 58 may also be a material which is sonic sealable and vibratory sealable. In the case of one type of heat sealable lacquer, the heat sealable lacquer may be applied to a sheet of material 5 and then heat, sound waves, or vibrations are then applied to effect the sealing.

The term “bonding material” also includes any heat or chemically shrinkable material, static, electrical or other electrical, magnetic, mechanical or barb-type fastening or clamps, curl-type characteristics of the film and the materials in a sheet of material which cause the sheet of material to take on certain shapes, and any type of welding method which may weld the sheet of material into an articulated bag.

The sheet of material 5 may further include at least one scent, the bonding material 58 may also include a scent, or both the sheet of material 5 and the bonding material 58 may include a scent. The scent may be incorporated into the structure of the sheet of material 5 during the fabrication of the sheet of material 5 or may be applied to the sheet of material 5 after it has been manufactured and before the sheet of material 5 is articulated into the bag of the present invention, such as bag 10 (FIG. 2). The scent may also be applied to the bag 10 of the present invention after it has been articulated from the sheet of material 5. Examples of scents utilized herein include floral scents (flower blossoms or other portions of plants), food scents (chocolate, sugar, fruits), herb or spice scents (cinnamon), and the like. Additional examples of scents include flowers (i.e. roses, daisies, lilacs), plants (i.e. fruits, vegetables, grasses, and trees), foods (i.e. candies, cookies, cake), food condiments (i.e. honey, sugar, salt), herbs, spices, woods, roots, and the like, or any combinations of the foregoing. Such scents are known in the art and commercially available.

The scent may be applied to the sheet of material 5 by spraying the scent thereon, painting the scent thereon, brushing the scent thereon, lacquering the scent thereon, immersing sheet of material the 5 in a scent-containing liquid, exposing the sheet of material 5 to the scent containing gas or any combination thereof. The scent may also be incorporated onto the sheet of material 5 during the manufacture, extrusion, and/or lamination of the sheet of material 5.

When articulated, the sheet of material 5 forms a generally tubular sheath, indicated by reference numeral 60 shown in FIG. 2. The tubular sheath 60 is provided with an interior surface 70, an exterior surface 80, a end top 90, and a bottom end 100. The tubular sheath 60 is articulated from the sheet of material 5 by folding the sheet of material 5 over and onto itself such that the first edge portion 40 of the sheet of material 5 is substantially adjacent the second edge portion 50 thereof. As shown in FIG. 2, where the first edge portion 40 is adjacent the second edge portion 50, a first area of engagement 120 is defined. When the sheet of material 5 is folded over and onto itself, the third edge portion 55 folds over and onto itself as well, thereby defining a second area of engagement 130. The first area of engagement 120 is exaggerated in size in FIG. 2 for purpose of description and it should be appreciated that the first area of engagement 120, in practice, may be substantially smaller and less noticeable. The first area of engagement 120 is generally shaped and sized as a fin seal—i.e., the first edge portion 40 is directly adjacent and in alignment with the second edge portion 50. The first area of engagement 120 also has an amount of the bonding material 58 disposed between the first edge portion 40 and the second edge portion 50 of the sheet of material 5 for affecting a seal therebetween. When sealed in this manner, the sheet of material 5 is articulated into the tubular sheath 60 having a fin seal seam, defined generally by the first area of engagement 120.

As stated above, the second area of engagement 130 is created by the third edge portion 55 being folded over onto itself. Through the creation of the second area of engagement 130, the bottom end 100 of the tubular sheath 60 is generally flattened. An amount of the bonding material 58, which is disposed on the third edge portion 55, is thus operably interspersed in the second area of engagement 130 such that the bottom end 100 is substantially closed. In the embodiment shown in FIG. 2, the bottom end 100 is sealed in a fin seal manner generally along the second area of engagement 130.

Thus, as shown in FIG. 2, when the first and second areas of engagement 120, 130 have been articulated and bondingly sealed, the bag 10 is formed. The bag 10 defines an interior retaining space 140 which is suitable for holding and retaining an item, such as a floral grouping or a corsage. Thus, the top end 90 of the bag 10 is in a substantially open and unobstructed configuration prior to an item being placed in the interior retaining space 140 of the bag 10 and the top end 90 coordinates with the interior retaining space 140 to provide egress to the interior retaining space 140. After an item is placed in the interior retaining space 140, the top end 90 may be crimped, folded, stapled, glued and/or mechanically closed in any manner whatsoever which allows for the retention of the item within the interior retaining space 140 of the bag 10.

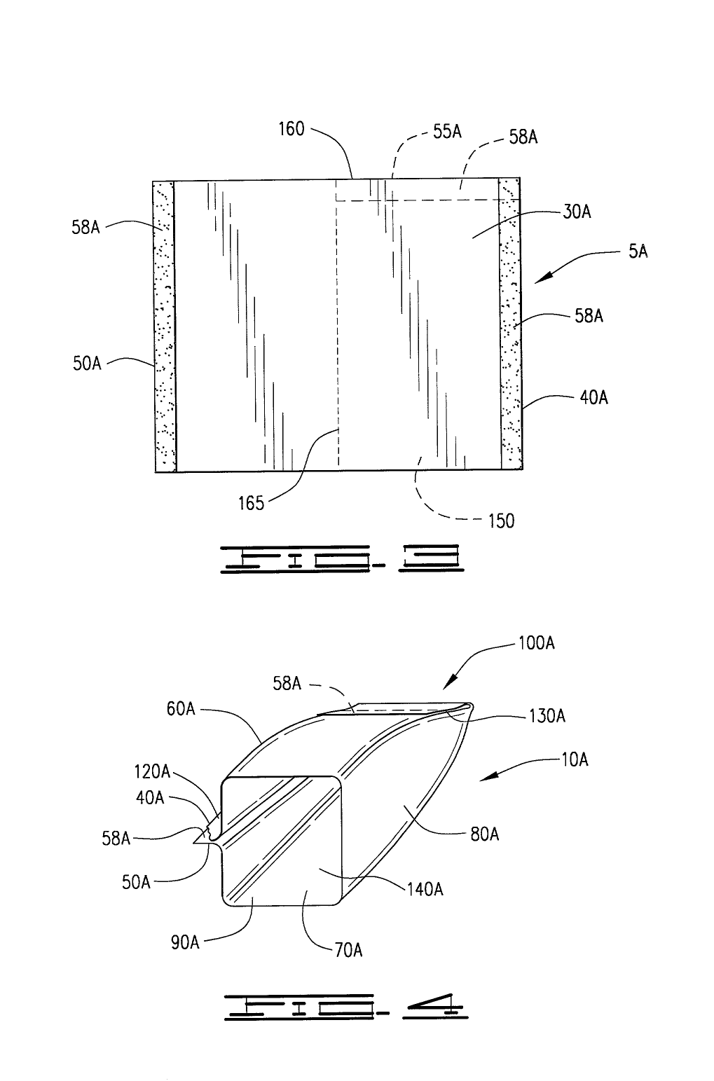

In an alternative embodiment of the invention, shown in FIGS. 3 and 4, a bag 10A (FIG. 4) is formed from a sheet of material 5A (FIG. 3) having a first surface 30A and a second surface 150. The first surface 30A includes a first edge portion 40A and a second edge portion 50A. The second surface 150 includes a third edge portion 55A. The third edge portion 55A does not extend the entire length of an outside edge 160 located on the second surface 150 of the sheet of material 5A: rather, the third edge portion 55A extends generally to a midpoint 165 of the sheet of material 5A, with the midpoint 165 being indicated generally by a dashed line shown in FIG. 3. A bonding material 58A is disposed on at least a portion of the first, second, and third edge portions 40A, 50A, and 55A, respectively. Thus, the first, second, and third edge portions 40A, 50A, and 55A, respectively, define areas of adhesion 57A. The remaining portion of the sheet of material 5A which is free of adhesive defines a substantially open area 59A which does not have the bonding material 58A thereon.

Still referring to FIG. 4, when articulated, the sheet of material 5A forms a generally tubular sheath 60A, having an interior surface 70A, an exterior surface 80A, a top end 90A, and a bottom end 100A. The tubular sheath 60A is articulated from the sheet of material 5A by folding the sheet of material 5A over and onto itself such that the first edge portion 40A is substantially adjacent the second edge portion 50A. The sheet of material 5A is folded generally along the midpoint 165 when forming the tubular sheath 60A.

As shown in FIG. 4, when the bag 10A is articulated, i.e. where the first edge portion 40A is adjacent the second edge portion 50A, a first area of engagement 120A is generally defined. Also, when the bag 10A is articulated, the third edge portion 55A is folded up toward the top end 90A such that the third edge portion 55A bondingly engages the exterior surface 80A of the tubular sheath 60A, and thereby defines a second area of engagement 130A. In the embodiment shown in FIGS. 3 and 4, the first area of engagement 120A is generally sized and shaped as a fin seal—i.e. the first edge portion 40A is adjacent the second edge portion 50A. The bonding material 58A is located between the first edge portion 40A and the second edge portion 50A of the sheet of material 5A such that first and second edge portions 40A and 50A are bondingly connected to one another so as to form the fin seal where the fin seal is generally defined by the first area of engagement 120A.

The second area of engagement 130A is generally characterized as being defined by a lap seal, i.e., the third edge portion 55A is folded up toward the top end 90A such that the third edge portion 55A bondingly engages the exterior surface 80A of the tubular sheath 60A. By creating this lap seal at the second area of engagement 130A, the bottom end 100A is substantially flattened and closed, thereby providing the tubular sheath 60A having two sealed areas of engagement 120A, 130A, respectively, and the substantially open top end 90A.

Thus, as shown in FIG. 4, when the first and second areas of engagement 120A, 130A have been articulated and bondingly sealed the bag 10A is formed. The bag 10A has an interior retaining space 140A which is suitable for holding and retaining an item, such as a floral grouping or a corsage. The top end 90A is in a substantially open and unobstructed configuration prior to an item being placed within the interior retaining space 140A. After an item is placed in the interior retaining space 140A, the top end 90A may be crimped, folded, stapled, and/or mechanically closed in any manner whatsoever which allows for the retention of the item in the interior retaining space 140A.

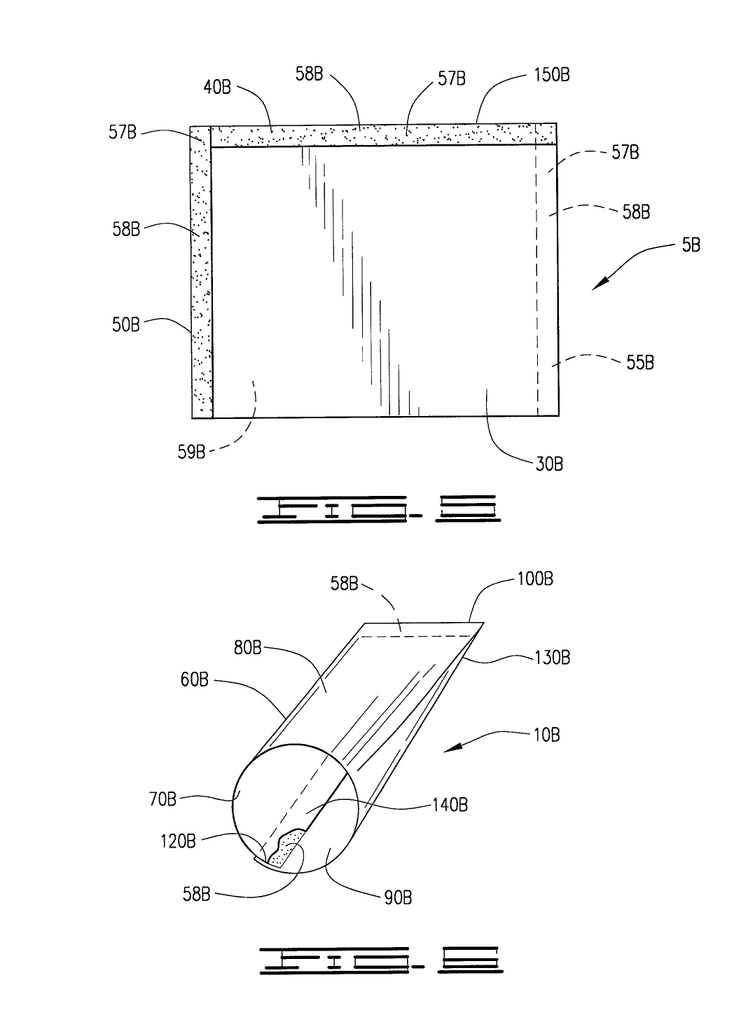

In another embodiment of the present invention, shown in FIGS. 5 and 6, a bag 10B (FIG. 6) is formed from a sheet of material 5B. The sheet of material 5B has a first surface 30B and a second surface 150B. The first surface 30B includes a first edge portion 40B and a second edge portion 50B. The second surface 150B includes a third edge portion 55B. A bonding material 58B is disposed on at least a portion of the first edge portion 40B, the second edge portion 50B, as well as on the third edge portion 55B. Thus, the first, second and third edge portions 40B, 50B, 55B, respectively, define areas of adhesion 57B. The remaining portion of the sheet of material 5B which is free of adhesive defines a substantially open area 59B which does not have the bonding material 58B thereon.

When articulated, the sheet of material 5B forms a generally tubular sheath 60B. The tubular sheath 60B further includes an interior surface 70B, an exterior surface 80B, a top end 90B, and a bottom end 100B.

The tubular sheath 60B is articulated from the sheet of material 5B by folding the sheet of material 5B over and onto itself such that the second edge portion 50B overlaps and is substantially adjacent the third edge portion 55B. As shown in FIG. 6, where the second edge portion 50B overlaps the third edge portion 55B, a first area of engagement 120B is defined. When the sheet of material 5B is folded, the first edge portion 40B is folded onto itself and defines a second area of engagement 130B.

The first area of engagement 120B is generally sized and shaped as a lap seal, i.e., the third edge portion 55B is adjacent the second edge portion 50B. The first area of engagement 120B also has an amount of the bonding material 58B disposed between the third edge portion 55B and the second edge portion 50B. The bonding material 58B holds and seals the second edge portion 50B adjacent the third edge portion 55B. When folded and sealed in this manner, the sheet of material 5B is articulated into the tubular sheath 60B having a lap-seal seam. This lap seal is defined generally by the first area of engagement 120B.

As stated above, the second area of engagement 130B is created by the first edge portion 40B being folded over and onto itself. Through the articulation of the second area of engagement 130B, the bottom end 100B of the tubular sheath 60B is generally flattened. The bonding material 58B, which is disposed on the first edge portion 40B, is thus operably interspersed within the second area of engagement 130B such that the flattened bottom end 100B of the tubular sheath 60B is held and sealed by the bonding material 58B. In the embodiment shown in FIG. 6, the bottom end 100B of the tubular sheath 60B is sealed in a fin seal manner generally along the second area of engagement 130B.

Thus, as shown in FIG. 6, when the first and second areas of engagement 120B and 130B have been articulated and bondingly sealed, the bag 10B is formed. The bag 100B has an interior retaining space 140B which is suitable for holding and retaining an item, such as a floral grouping or a corsage. The top end 90B is in a substantially open and unobstructed configuration prior to an item being placed in the interior retaining space 140B. After an item is placed in the interior retaining space 140B, the top end 90B may be crimped, folded, stapled, curved, and/or mechanically closed in any manner whatsoever which allows for the retention of the item within the interior retaining space 140B.

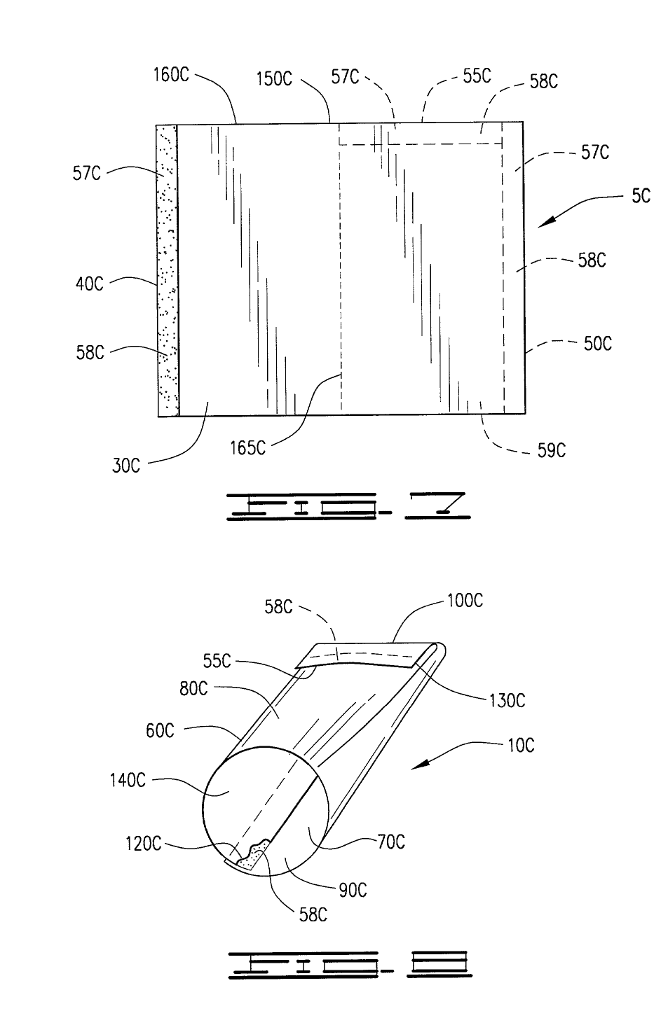

In an additional embodiment of the present invention, shown in FIGS. 7 and 8, a bag 10C is formed from a sheet of material 5C. The sheet of material 5C has a first surface 30C and a second surface 150C. The first surface 30C includes a first edge portion 40C. The second surface 150C includes a second edge portion 50C and a third edge portion 55C. The third edge portion 55C does not extend along the entire length of an outside edge 160C of the second surface 150C; rather, the third edge portion 55C extends generally to a midpoint 165C of the sheet of material 5C, with the midpoint 165C being indicated generally by a dashed line in FIG. 7.

A bonding material 58C is applied to at least a portion of the first, second, and third edge portions 40C, 50C, and 55C, respectively. Thus, the first, second and third edge portions 40C, 50C, and 55C, respectively, define areas of adhesion 57C. The remaining portion of the sheet of material 5C which is free of adhesive defines a substantially open area 59C which does not have the bonding material 58C thereon.

When articulated, the sheet of material 5C forms a generally tubular sheath 60C, having an interior surface 70C, an exterior surface 80C, a top end 90C, and a bottom end 100C.

The tubular sheath 60C is articulated from the sheet of material 5C by folding the sheet of material 5C over and onto itself such that the first edge portion 40C overlaps and is substantially adjacent to the second edge portion 50C. As shown in FIG. 8, where the first edge portion 40C overlaps the second edge portion 50C, a first area of engagement 120C is defined. During folding, the third edge portion 55C is folded over and onto itself defining a second area of engagement 130C.

The first area of engagement 120C is generally sized and shaped as a lap seal, i.e., the first edge portion 40C is adjacent the second edge portion 50C. The first area of engagement 120C also has an amount of the bonding material 58C disposed between the first edge portion 40C and the second edge portion 50C. The bonding material 58C holds and seals the first edge portion 40C adjacent the second edge portion 50C. When folded and sealed in this manner, the sheet of material 5C is articulated into the tubular sheath 60C having a lap seal seam. This lap seal seam is defined generally by the first area of engagement 120C.

The second area of engagement 130C is generally formed into a lap seal, i.e., the third edge portion 55C is folded up and bonded to the top end 90C of the tubular sheath 60C such that the third edge portion 55C bondingly engages the exterior surface 80C of the tubular sheath 60C. By creating this lap seal at the second area of engagement 130C, the bottom end 100C of the tubular sheath 60C is substantially flattened, closed, and sealed by the bonding material 58C disposed on the third edge portion 55C. The tubular sheath 60C is thereby provided having the two sealed first and second areas of engagement 120C, 130C and the substantially open top end 90C.

Thus, as shown in FIG. 8, when the first and second areas of engagement 120C, 130C have been articulated and bonded, the bag 10C is formed. The bag 10C has an interior retaining space 140C which is suitable for holding and retaining an item, such as a floral grouping or a corsage. The top end 90C is in a substantially open and unobstructed configuration prior to an item being placed in the interior retaining space 140C. After an item is placed in the interior retaining space 140C, the top end 90C may be crimped, folded, stapled, and/or mechanically closed in any manner whatsoever which allows for the retention of the item in the interior retaining space 140C.

Thus it should be apparent that there has been provided in accordance with the present invention a bag that fully satisfies the objectives and advantages set forth above. Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A bag, comprising:
a sheet of material having a first surface and a second surface, the sheet of material folded to form a tubular sheath with a portion of the first surface engagingly overlapping the second surface along a first area of engagement, the tubular sheath having an interior surface, an exterior surface, a top end and a bottom end, the bottom end of the tubular sheath being crimped to form a crimped bottom end, the crimped bottom end being folded toward the top end of the tubular sheath such that a first portion of the exterior surface of the tubular sheath engages a second portion of the exterior surface of the tubular sheath to define a second area of engagement; and
a bonding material disposed on a selected portion of the first surface of the sheet of material such that when the sheet of material is folded to form the tubular sheaths, the bonding material is positioned solely on the first area of engagement and the second area of engagement to seal the first surface of the sheet of material to the second surface of the sheet of material along the first area of engagement and to seal the first portion of the exterior surface of the tubular sheath to the second portion of the exterior surface of the tubular sheath along the second area of engagement.

2. The bag of claim 1, wherein the sheet of material is has a thickness in a range of from 0.1 mil to about 30 mil.

3. The bag of claim 1, wherein the sheet of material is selected from the group consisting of treated or untreated paper, cellophane, metal foil, polymer film, non-polymer film, cardboard, fiber, cloth, burlap, laminations and combinations thereof.

4. The bag of claim 1, wherein the bonding material is a cohesive or an adhesive.

5. The bag of claim 1, wherein the bonding material is a heat sealable lacquer.

6. A bag, comprising:
a sheet of material having a first surface having a first edge portion and a second edge portion, the sheet of material folded to form a tubular sheath with the first surface first edge portion engaging the first surface second edge portion along a first area of engagement, the tubular sheath having an interior surface, an exterior surface, a top end and a bottom end, the bottom end of the tubular sheath being crimped to form a crimped bottom end, the crimped bottom end being folded toward the top end of the tubular sheath such that a first portion of the exterior surface of the tubular sheath engages a second portion of the exterior surface of the tubular sheath to define a second area of engagement; and
a bonding material disposed solely on the first area of engagement and the second area of engagement to seal the first surface first edge portion to the first surface second edge portion along the first area of engagement and to seal the first portion of the exterior surface of the tubular sheath to the second portion of the exterior surface of the tubular sheath along the second area of engagement.

7. The bag of claim 6, wherein the sheet of material has a thickness in a range of from 0.1 mil to about 30 mil.

8. The bag of claim 6, wherein the sheet of material is selected from the group consisting of treated or untreated paper, cellophane, metal foil, polymer film, non-polymer film, cardboard, fiber, cloth, burlap, laminations and combinations thereof.

9. The bag of claim 6, wherein the bonding material is a cohesive or an adhesive.

10. The bag of claim 6, wherein the bonding material is a heat sealable lacquer.

11. A bag, comprising:
a sheet of material having a first surface and a second surface, the sheet of material folded to form a tubular sheath with a portion of the first surface engagingly overlapping the second surface along a first area of engagement, the tubular sheath having an interior surface, an exterior surface, a top end and a bottom end, the bottom end of the tubular sheath being crimped to form a crimped bottom end to define a second area of engagement; and
a bonding material disposed solely on the first area of engagement and the second area of engagement to seal the first surface to the second surface along the first area of engagement and to seal the crimped bottom end of the tubular sheath along the second area of engagement.

12. The bag of claim 11, wherein the sheet of material has a thickness in a range of from 0.1 mil to about 30 mil.

13. The bag of claim 11, wherein the sheet of material is selected from the group consisting of treated or untreated paper, cellophane, metal foil, polymer film, non-polymer film, cardboard, fiber, cloth, burlap, laminations and combinations thereof.

14. The bag of claim 11, wherein the bonding material is a cohesive or an adhesive.

15. The bag of claim 11, wherein the bonding material is a heat sealable lacquer.

16. A bag, comprising:
a sheet of material having a first surface having a first edge portion and a second edge portion, the sheet of material folded to form a tubular sheath with the first surface first edge portion engaging the first surface second edge portion along a first area of engagement, the tubular sheath having an interior surface, an exterior surface, a top end and a bottom end, the bottom end of the tubular sheath being crimped to form a crimped bottom end to define a second area of engagement; and
a bonding material disposed solely on the first area of engagement and the second area of engagement to seal the first surface first edge portion to the first surface second edge portion along the first area of engagement and to seal the crimped bottom end of the tubular along the second area of engagement.

17. The bag of claim 16, wherein the sheet of material has a thickness in a range of from 0.1 mil to about 30 mil.

18. The bag of claim 16, wherein the sheet of material is selected from the group consisting of treated or untreated paper, cellophane, metal foil, polymer film, non-polymer film, cardboard, fiber, cloth, burlap, laminations and combinations thereof.

19. The bag of claim 16, wherein the bonding material is a cohesive or an adhesive.

20. The bag of claim 16, wherein the bonding material is a heat sealable lacquer.

21. A method for forming a bag, comprising the steps of:
providing a sheet of material, the sheet of material having a first surface and a second surface, the sheet of material folded to form a tubular sheath with a portion of the first surface engagingly overlapping the second surface along a first area of engagement, the tubular sheath having an interior surface, an exterior surface, a top end and a bottom end, the bottom end of the tubular sheath being crimped to form a crimped bottom end, the crimped bottom end being folded toward the top end of the tubular sheath such that a first portion of the exterior surface of the tubular sheath engages a second portion of the exterior surface of the tubular sheath to define a second area of engagement; and
disposing a bonding material solely on the first area of engagement and the second area of engagement to seal the first surface to the second surface along the first area of engagement and to seal the first portion of the exterior surface of the tubular sheath to the second portion of the exterior surface of the tubular sheath along the second area of engagement.

22. The method of claim 21, wherein in the step of providing a sheet of material, the sheet of material has a thickness in a range of from 0.1 mil to about 30 mil.

23. The method of claim 21, wherein in the step of providing a sheet of material, the sheet of material is selected from the group consisting of treated or untreated paper, cellophane, metal foil, polymer film, non-polymer film, cardboard, fiber, cloth, burlap, laminations and combinations thereof.

24. The method of claim 21, wherein in the step of disposing a bonding material, the bonding material is a cohesive or an adhesive.

25. The method of claim 2 1, wherein in the step of disposing a bonding material, the bonding material is a heat sealable lacquer.

26. A method for forming a bag, comprising the steps of:
providing a sheet of material, the sheet of material having a first surface having a first edge portion and a second edge portion, the sheet of material folded to form a tubular sheath with the first surface first edge portion engaging the first surface second edge portion along a first area of engagement, the tubular sheath having an interior surface, an exterior surface, a top end and a bottom end, the bottom end of the tubular sheath being crimped to form a crimped bottom end, the crimped bottom end being folded toward the top end of the tubular sheath such that a first portion of the exterior surface of the tubular sheath engages a second portion of the exterior surface of the tubular sheath to define a second area of engagement; and
disposing a bonding material solely on the first area of engagement and the second area of engagement to seal the first surface first edge portion to the first surface second edge portion along the first area of engagement and to seal the first portion of the exterior surface of the tubular sheath to the second portion of the exterior surface of the tubular sheath along the second area of engagement.

27. The method of claim 26, wherein in the step of providing a sheet of material, the sheet of material has a thickness in a range of from 0.1 mil to about 30 mil.

28. The method of claim 26, wherein in the step of providing the sheet of material, the sheet of material is selected from the group consisting of treated or untreated paper, cellophane, metal foil, polymer film, non-polymer film, cardboard, fiber, cloth, burlap, laminations and combinations thereof.

29. The method of claim 26, wherein in the step of disposing a bonding material, the bonding material is a cohesive or an adhesive.

30. The method of claim 26, wherein in the step of disposing the bonding material, the bonding material is a heat sealable lacquer.

31. A method for forming a bag, comprising the steps of:
providing a sheet of material, the sheet of material having a first surface and a second surface, the sheet of material folded to form a tubular sheath with a portion of the first surface engagingly overlapping the second surface along a first area of engagement, the tubular sheath having an interior surface, an exterior surface, a top end and a bottom end, the bottom end of the tubular sheath being crimped to form a crimped bottom end to define a second area of engagement; and
disposing a bonding material solely on the first area of engagement and the second area of engagement to seal the first surface to the second surface along the first area of engagement and to seal the crimped bottom end of the tubular sheath along the second area of engagement.

32. The method of claim 31, wherein in the step of providing the sheet of material, the sheet of material has a thickness in a range of from 0.1 mil to about 30 mil.

33. The method of claim 31, wherein in the step of providing the sheet of material, the sheet of material is selected from the group consisting of treated or untreated paper, cellophane, metal foil, polymer film, non-polymer film, cardboard, fiber, cloth, burlap, laminations and combinations thereof.

34. The method of claim 31, wherein in the step of disposing the bonding material, the bonding material is a cohesive or an adhesive.

35. The method of claim 31, wherein in the step of disposing the bonding material, the bonding material is a heat sealable lacquer.

36. A method for forming a bag, comprising the steps of:
providing a sheet of material, the sheet of material having a first edge portion and a second edge portion, the sheet of material folded to form a tubular sheath with the first surface first edge portion engaging the first surface second edge portion along a first area of engagement, the tubular sheath having an interior surface, an exterior surface, a top end and a bottom end, the bottom end of the tubular sheath being crimped to form a crimped bottom end to define a second area of engagement; and
disposing a bonding material solely on the first area of engagement and the second area of engagement to seal the first surface first edge portion to the first surface second edge portion along the first area of engagement and to seal the crimped bottom end of the tubular along the second area of engagement.

37. The method of claim 36, wherein in the step of providing the sheet of material, the sheet of material has a thickness in a range of from 0.1 mil to about 30 mil.

38. The method of claim 36, wherein in the step of providing the sheet of material, the sheet of material is selected from the group consisting of treated or untreated paper, cellophane, metal foil, polymer film, non-polymer film, cardboard, fiber, cloth, burlap, laminations and combinations thereof.

39. The method of claim 36, wherein in the step of disposing the bonding material, the bonding material is a cohesive or an adhesive.

40. The method of claim 36, wherein in the step of disposing the bonding material, the bonding material is a heat sealable lacquer.
